(19) United States
(12) Patent Application Publication
(10) Pub. No.: US 2007/0103408 A1
(43) Pub. Date: May 10, 2007

(54) Self-luminous display apparatus, light emission condition control apparatus, light emission condition control method and program

(76) Inventors: Mitsuru Tada, Kanagawa (JP); Atsushi Ozawa, Kanagawa (JP)

Correspondence Address: ROBERT J. DEPKE;LEWIS T. STEADMAN, ROCKEY, DEPKE, LYONS AND KITZINGER, LLC, SUITE 5450 SEARS TOWER, CHICAGO, IL, 60606-6306, US

(21) Appl. No.: 11/593,324

(22) Filed: Nov. 6, 2006

(30) Foreign Application Priority Data
Nov. 9, 2005 (JP) JP 2005-324738

(51) Int. Cl. G09G 3/30

(52) U.S. Cl. 345/76

(57) ABSTRACT

Disclosed herein is a self-luminous display apparatus including a light emission panel whose light emission time period can be varied within a period of one frame, including: an area-specific motion decision section configured to make a decision between a moving picture area and a still picture area for each one frame; a frame-specific motion decision section configured to decide a frame having a high ratio of moving picture areas as a moving picture frame but decide a frame having a low ratio of moving picture areas as a still picture frame; and a light emission condition control section configured to control, when a frame decided as a moving picture frame by the frame-specific motion decision section is to be displayed, so that a peak luminance to be visually observed may be kept fixed and to decrease the light emission time period of the light emission panel from a reference light emission time period.

### CROSS REFERENCES TO RELATED APPLICATIONS

The present invention contains subject matter related to Japanese Patent Application JP 2005-324738 filed in the Japanese Patent Office on Nov. 9, 2005, the entire contents of which being incorporated herein by reference.

### BACKGROUND OF THE INVENTION

1. Field of the Invention

This invention relates to a self-luminous display apparatus, a light emission condition control apparatus, a light emission condition control method and a program.

2. Description of the Related Art

An organic EL display apparatus is superior in the wide view angle characteristic, high response speed, wide color reproduction range and high contrast and also in that it allows a display panel itself to be formed with a small thickness. Due to the advantages mentioned, an organic EL display apparatus draws attention as the most promising candidate for a next-generation flat panel display apparatus.

Incidentally, also an organic EL display apparatus preferably has a peak luminance as high as possible in order to display a television program with high quality. In order to raise the peak luminance, it is necessary to raise the input voltage and also to increase the light emission time period within a period of one frame. Various variable control apparatus for a light emission time period are known and disclosed, for example, in Japanese Patent Laid-Open No. 2003-15605, Japanese Patent Laid-Open No. 2001-343941 and Japanese Patent Laid-Open No. 2002-132218.

### SUMMARY OF THE INVENTION

However, as the light emission time period within a period of one frame increases, it becomes difficult to assure the moving picture responsibility. For example, it becomes difficult for a user to read characters where a telop, which has a display form wherein characters are displayed in a flowing fashion in a horizontal direction, at a lower portion of a screen.

In this instance, if the light emission time period within a period of one frame is decreased, then the moving picture responsibility is improved. However, this deteriorates the picture quality because it gives rise to a drop of the peak luminance.

In this manner, increase of the peak luminance and enhancement of the moving picture responsibility are in a reciprocal relationship to each other.

Therefore, it is demanded to provide a self-luminous display apparatus, a light emission condition control apparatus, a light emission condition control method and a program wherein, where the light emission time period of a light emission panel can be varied within a period of one frame, the moving picture responsibility can be enhanced actively while a peak luminance is maintained.

According to an embodiment of the present invention, there is provided a self-luminous display apparatus including a light emission panel whose light emission time period can be varied within a period of one frame, includes an area-specific motion decision section configured to make a decision between a moving picture area and a still picture area for each one frame, a frame-specific motion decision section configured to decide a frame having a high ratio of moving picture areas as a moving picture frame but decide a frame having a low ratio of moving picture areas as a still picture frame, and a light emission condition control section configured to control, when a frame decided as a moving picture frame by the frame-specific motion decision section is to be displayed, so that a peak luminance to be visually observed may be kept fixed and to decrease the light emission time period of the light emission panel from a reference light emission time period.

In order keep to the peak luminance fixed, various methods are available. For example, the maximum driving voltage or maximum driving current for the light emission panel is increased in response to decrease of the light emission time period such that the product of the maximum driving voltage or maximum driving current and the light emission time period before and after the decrease of the light emission time period is kept fixed. Or, pixel data are increased in magnitude in repose to decrease of the light emission time period so that the product of the mean value (in unit of a frame) of the pixel data and the light emission time period before and after the decrease of the light emission time period is controlled to a fixed value.

According to another embodiment of the present invention, there is provided a self-luminous display apparatus including a light emission device whose light emission time period can be varied within a period of one frame, including a frequency distribution measurement section configured to detect a frequency distribution of gradation values which provide luminance components of a video signal for each of sub areas which form one frame, a sub area-specific representative value calculation section configured to perform weighted arithmetic operation of the frequencies detected with regard to each sub area for each class such that comparatively great weights are applied to the classes corresponding to a low gradation region and a high gradation region to calculate representative values which provide indices to same gradation region components included in the individual sub areas, a variation degree calculation section configured to compare the representative values calculated with regard to a preceding frame and a current frame for the individually same sub areas to calculate the degree of variation on the current frame, a sub area-specific motion decision section configured to decide a sub area having a variation degree greater than or equal to a criterion value as a moving picture area but decide a sub area having a variation degree lower than the criterion value as a still picture area, a frame-specific motion decision section configured to compare the number of moving picture areas and the number of still picture areas with each other in a unit of one frame and decide a sub area as a moving picture area if the number of moving picture areas thereof is equal to greater than the number of still picture areas thereof but decide a sub area as a still picture area if the number of still picture areas thereof is greater than the number of moving picture areas thereof, and a light emission condition control section configured to control, when a frame decided as a moving picture frame by the frame-specific motion decision section is to be displayed, so that a peak luminance to be visually observed may be kept fixed and to decrease the light emission time period of the light emission panel from a reference light emission time period.

According to a further embodiment of the present invention, there is provided a self-luminous display apparatus including a light emission device whose light emission time period can be varied within a period of one frame, including a frequency distribution measurement section configured to detect a frequency distribution of gradation values which provide luminance components of a video signal for each of sub areas which form one frame, a sub area-specific representative value calculation section configured to perform weighted arithmetic operation of the frequencies detected with regard to each sub area for each class such that comparatively great weights are applied to the classes corresponding to a low gradation region and a high gradation region to calculate representative values which provide indices to same gradation region components included in the individual sub areas, a variation degree calculation section configured to compare the representative values calculated with regard to a preceding frame and a current frame for the individually same sub areas to calculate the degree of variation on the current frame, a sub area-specific motion decision section configured to decide a sub area having a variation degree greater than or equal to a criterion value as a moving picture area but decide a sub area having a variation degree lower than the criterion value as a still picture area, and a light emission condition control section configured to control, in response to the ratio between the number of moving picture areas and the number of still picture areas in a unit of one frame, so that a peak luminance to be visually observed may be kept fixed and to decrease the light emission time period of the light emission panel from a reference light emission time period.

According to a still further embodiment of the present invention, there is provided a self-luminous display apparatus including a light emission panel whose light emission time period can be varied within a period of one frame, including an area-specific motion decision section configured to decide, based on motion information included in an input video signal, whether each of encoded areas which form one frame is an interframe encoded moving picture area or an intraframe encoded still picture area, a frame-specific motion decision section configured to decide that a frame which exhibits a high ratio of moving picture frames is a moving picture frame but a frame which exhibits a low ratio of moving picture frames is a still picture frame, and a light emission condition control section configured to control, when a frame decided as a moving picture frame is to be displayed, so that a peak luminance to be visually observed may be kept fixed and to decrease the light emission time period of the light emission panel from a reference light emission time period.

According to a yet further embodiment of the present invention, there is provided a self-luminous display apparatus including a light emission panel whose light emission time period can be varied within a period of one frame, including a frame-specific motion decision section configured to decide that a frame which includes a display column only for character data is a still picture frame but a frame which does not include a display column only for character data is a moving picture frame, and a light emission condition control section configured to control, when a frame decided as a moving picture frame is to be displayed, so that a peak luminance to be visually observed may be kept fixed and to decrease the light emission time period of the light emission panel from a reference light emission time period.

With the self-luminous display apparatus, both of high picture quality and high moving picture responsibility can be implemented while the peak luminance is kept fixed.

Further, with the self-luminous display apparatus, reduction of the arithmetic operation load for the decision of a moving picture frame or reduction of the circuit scale can be anticipated. Therefore, also where a frame is composed of a large number of pixels, a decision process on the real-time basis can be achieved.

The above features and advantages of the present invention will become apparent from the following description and the appended claims, taken in conjunction with the accompanying drawings in which like parts or elements denoted by like reference symbols.

### BRIEF DESCRIPTION OF THE DRAWINGS

FIGS. 1A and 1B are diagrams illustrating a relationship between the output voltage and the light emission luminance and a relationship between the light emission time period and the light emission luminance, respectively;

FIG. 2 is a diagram illustrating a condition in which the peak luminance is maintained;

FIG. 3 is a block diagram showing an example of a structure of an organic EL panel module;

FIGS. 4A, 4B and 4C are waveform diagrams illustrating examples of a duty pulse for controlling the light emission time length;

FIG. 5 is a block diagram showing the structure of the organic EL panel module and showing that a light emission condition control apparatus is incorporated in the organic EL panel module;

FIG. 6 is a block diagram showing a form example 1 of the light emission condition control apparatus;

FIG. 7 is a diagrammatic view illustrating an example of division into sub areas;

FIG. 8 is a block diagram showing a form example 2 of the light emission condition control apparatus;

FIG. 9 is a block diagram showing an example of a structure of an area division histogram calculation section shown in FIG. 8;

FIG. 10 is a diagrammatic view showing an example of a frequency distribution regarding a certain sub area;

FIG. 11 is a block diagram showing an example of a structure of a motion decision section shown in FIG. 8;

FIG. 12 is a view illustrating an example of weighting;

FIG. 13 is a flow chart illustrating an example of a processing procedure executed by the motion decision section of FIG. 11;

FIG. 14 is a view illustrating an example of control of the light emission condition where the voltage and the output luminance have a proportional relationship to each other;

FIG. 15 is a similar view but illustrating an example of control of the light emission condition where the voltage and the output luminance have a square relationship to each other;

FIG. 16 is a block diagram showing a form example 3 of the light emission condition control apparatus;

FIG. 17 is a block diagram showing a form example 4 of the light emission condition control apparatus;

FIG. 18 is a block diagram showing a form example 5 of the light emission condition control apparatus;

FIGS. 19A and 19B illustrate an example of division into sub areas where a display screen includes a display column only for character data;

FIGS. 20A and 20B illustrate another example of division into sub areas where the display screen includes a display column only for character data; and

FIGS. 21A and 21B illustrate a further example of division into sub areas where the display screen includes a display column only for character data.

### DETAILED DESCRIPTION OF THE PREFERRED EMBODIMENTS

In the following, a self-luminous display apparatus to which the present invention is applied is described taking an organic EL panel module incorporating a processing function which can be implemented by the present invention as an example.

It is to be noted that, to matters which are not specifically described herein or not specifically illustrated in the accompanying drawings, well-known or publicly known techniques in the pertaining technical field are applied.

A. Condition for Maintaining a Peak Luminance

The luminance of a display panel can be adjusted by variably controlling the output voltage or output current applied to or the light emission time period of a display element when maximum data is inputted.

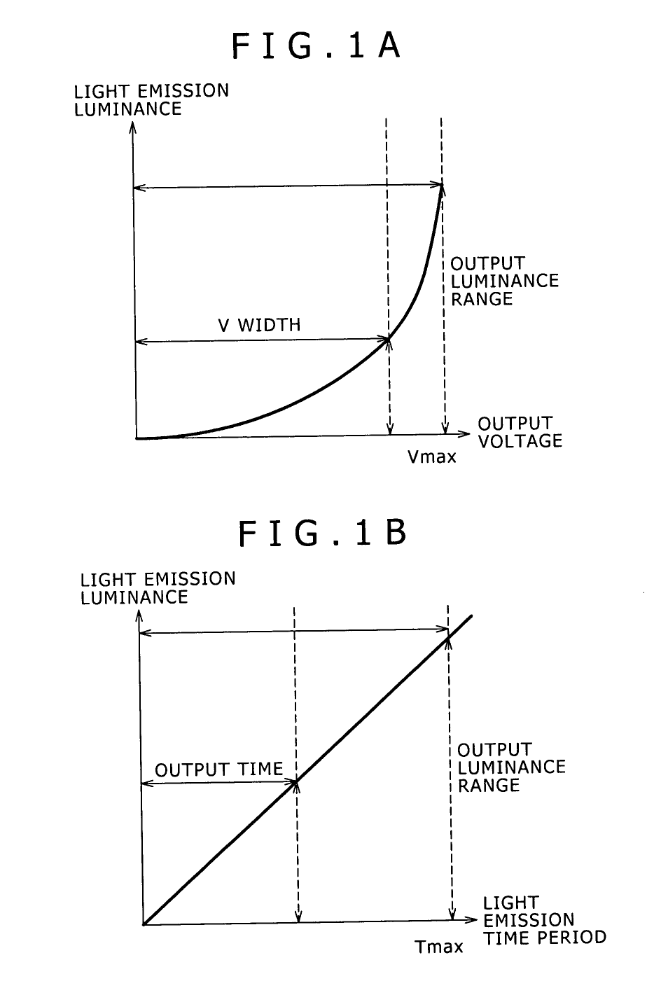

FIG. 1A illustrates a relationship between the output voltage and the light emission luminance, and FIG. 1B illustrates a relationship between the light emission time period and the light emission luminance. It is to be noted that FIG. 1B illustrates the relationship mentioned where the light emission time period and the light emission luminance have a linear relationship to each other. However, the light emission time period and the light emission luminance sometimes have a non-linear relationship.

The peak luminance of a display panel is given by the product S of the output voltage Vmax (output current Imax) applied to a display element and the light emission time period when maximum data is inputted.

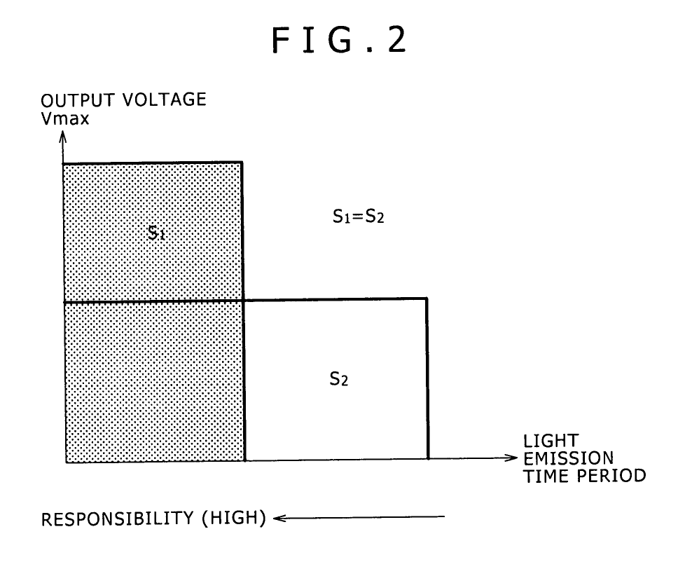

Accordingly, if the output voltage Vmax (output current Imax) and the light emission time period are variably controlled relative to each other so that the product S may not vary, then the peak luminance perceived by a human being can be kept fixed. FIG. 2 illustrates the principle just described. In particular, FIG. 2 illustrates that the product S₁ where the output voltage Vmax is raised while the light emission time is decreased and the product S₂ where the output voltage Vmax is lowered while the light emission time is increased are equal to each other.

If the light emission time period is controlled so as to be reduced while the product of the output voltage Vmax and the light emission time period is maintained before and after the control in this manner, then a display panel which can raise the moving picture response speed without allowing a human being to perceive a variation of the peak luminance by the control can be implemented.

It is to be noted that, for the determination of the output voltage Vmax and the light emission time period whose product is to be kept fixed, it is preferable to take the characteristic between the voltage and the light emission luminance and the characteristic between the light emission time period and the light emission luminance into consideration.

B. Example of the Structure of the Organic EL Panel

Now, an example of a structure of the organic EL panel module is described.

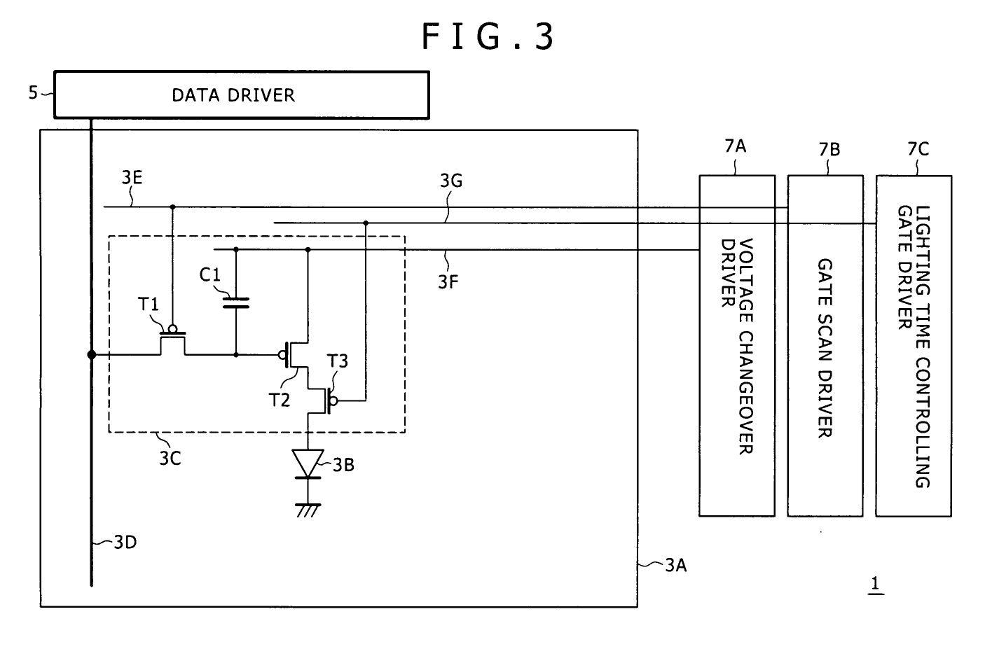

FIG. 3 shows an example of the structure of the organic EL panel module 1. Referring to FIG. 3, the organic EL panel module 1 includes a light emission region 3A in which organic EL elements are arrayed in a matrix, and a panel driving circuit for controlling display of an image.

The panel driving circuit includes a data driver 5, a voltage changeover driver 7A, a gate scan driver 7B, and a lighting time controlling gate driver 7C. The panel driving circuit is formed at a peripheral portion of the light emission region 3A.

An organic EL element 3B corresponding to each pixel and a pixel driving circuit 3C for the organic EL element 3B are disposed at an intersecting point between each data line 3D and each scanning line 3E. The pixel driving circuit 3C includes a data switch element T1, a capacitor C1, a current driving element T2 and a lighting switch element T3.

The data switch element T1 is used to control the fetching timing of a voltage value provided through the data line 3D. The fetching timing is provided line-sequentially through the scanning line 3E.

The capacitor C1 is used to retain the fetched voltage value for a period of time of one frame. Plane-sequential driving is implemented by the use of the capacitor C1.

The current driving element T2 is used to supply current corresponding to the voltage value of the capacitor C1 to the organic EL element 3B. The driving current is supplied from a current supply line 3F. It is to be noted that the voltage value to be applied to the current supply line 3F is variably controlled through changeover control of the light emission time period so that the condition of the fixed product illustrated in FIG. 2 may be satisfied.

The lighting switch element T3 is used to control supply of the driving current to the organic EL element 3B. The lighting switch element T3 is disposed in series to the supply path of the driving current. The organic EL element 3B emits light while the lighting switch element T3 keeps a closed state. On the other hand, while the lighting switch element T3 is open, the organic EL element 3B emits no light.

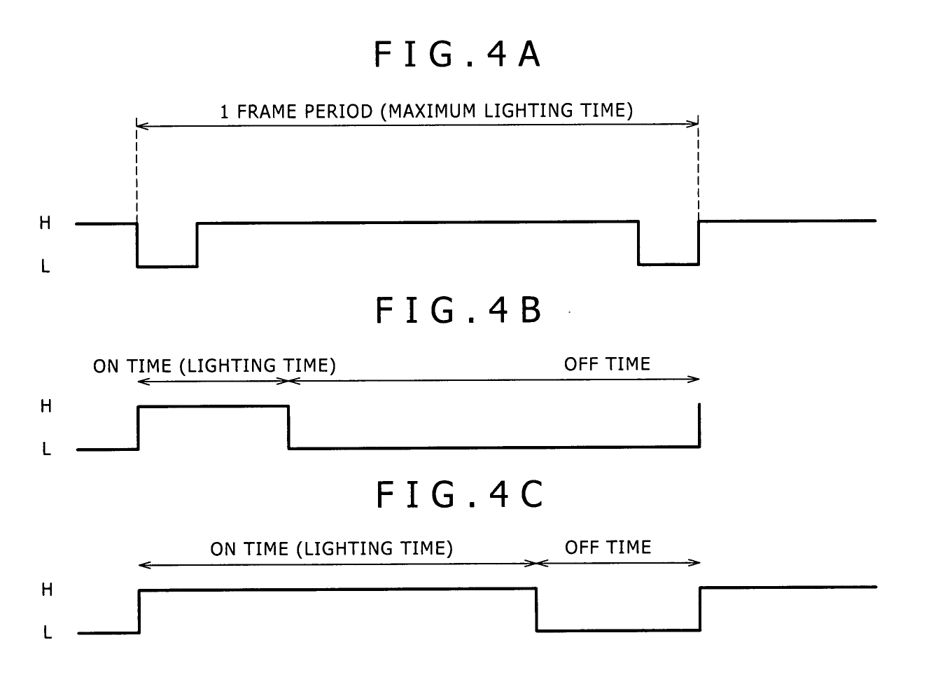

A lighting control line 3G supplies a duty pulse for controlling the opening and closing action of the lighting switch element T3. The duty pulse is illustrated in FIGS. 4B and 4C. It is to be noted that FIG. 4A illustrates a one-frame period as a reference time period. Meanwhile, FIG. 4B illustrates an example of the duty pulse for a moving picture frame, and FIG. 4C illustrates an example of the duty pulse for a still picture frame.

Referring back to FIG. 3, the changeover control of the voltage to be applied to the current supply line 3F is executed by the voltage changeover driver 7A. On the other hand, the changeover control of the light emission time period is executed by the lighting time controlling gate driver 7C. Such control signals for the drivers are supplied from a light emission condition control apparatus hereinafter described.

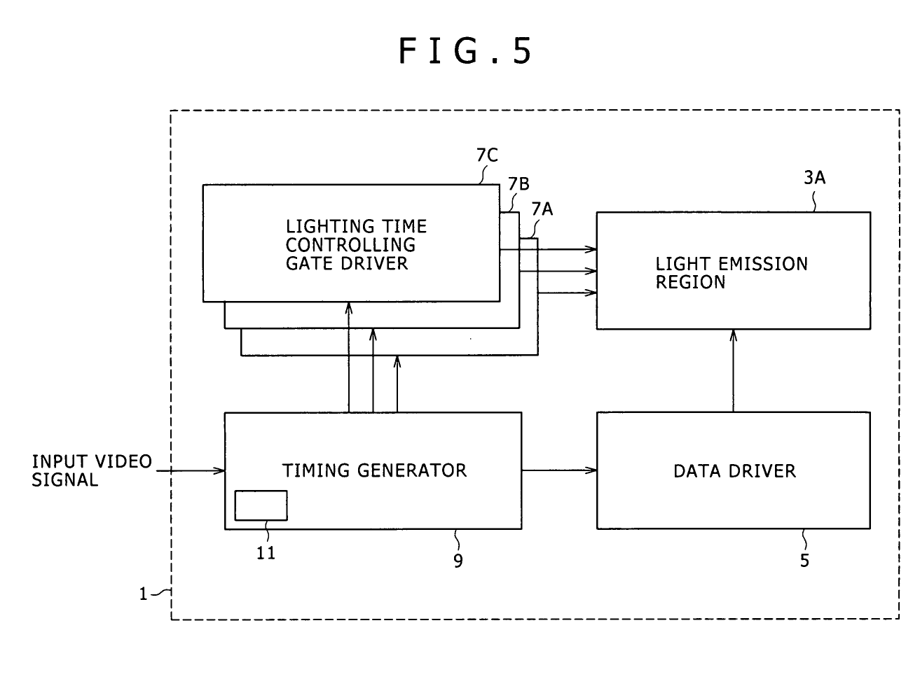

FIG. 5 shows an example of the structure of the organic EL panel module 1 which incorporates the light emission region 3A in which the pixel driving circuit 3C is formed. In the arrangement of FIG. 5, the light emission condition control apparatus 11 is mounted as part of a timing generator 9.

It is to be noted that a peripheral circuit of the light emission region 3A, that is, the panel driving circuit, may be incorporated as a semiconductor integrated circuit on a panel board or may be formed directly on a panel board using a semiconductor process.

C. Examples of the Form of the Light Emission Condition Control Apparatus

Several examples of the form of the light emission condition control apparatus 11 shown in FIG. 5 which implements changeover control of the output voltage Vmax and the light emission time period while the peak luminance is kept fixed are described below.

C-1. Form Example 1

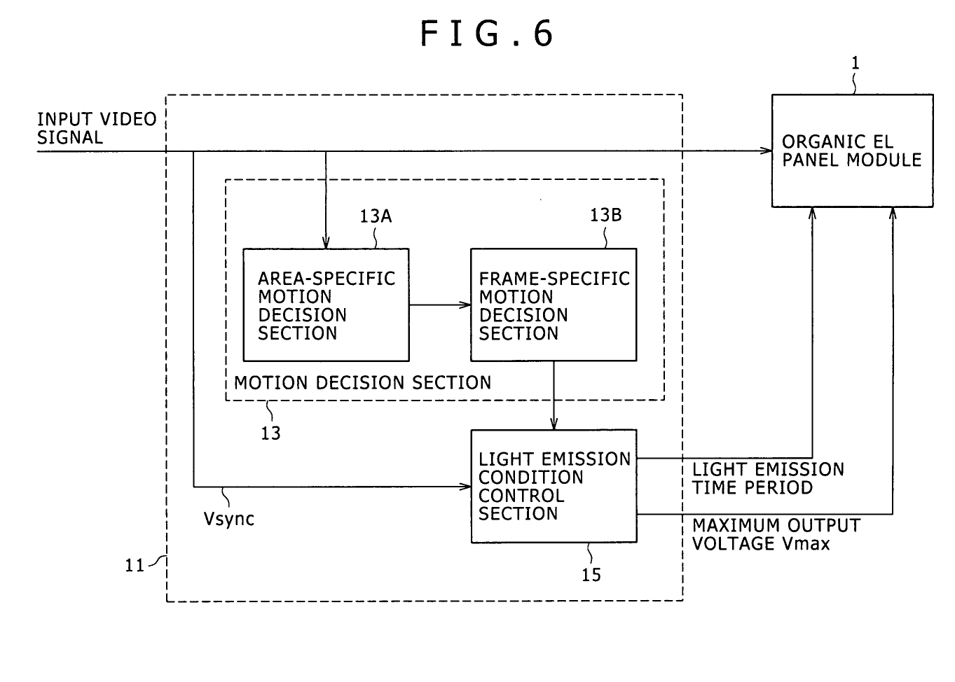

FIG. 6 shows an example of a configuration suitably adopted for the light emission condition control apparatus 11.

Referring to FIG. 6, the light emission condition control apparatus 11 according to the present form example includes a motion decision section 13 and a light emission condition control section 15.

The motion decision section 13 is provided for detection of a moving picture frame for which a high moving picture responsibility is required. The control action of the light emission condition control section 15 is changed over adaptively based on a result of the detection of the motion decision section 13. While various techniques in related art are available as a technique for detection of a moving picture frame, since the number of pixels which construct a display panel tends to increase, a processing method is demanded which is small in circuit scale and is light in burden of the circuit configuration or processing.

Therefore, the motion decision section 13 shown in FIG. 6 adopts a technique of dividing one frame into a plurality of areas and executing a moving picture decision of the entire frame using a result of the moving picture decision regarding the individual areas.

To this end, the motion decision section 13 includes an area-specific motion decision section 13A, and a frame-specific motion decision section 13B.

The motion decision section 13 divides one frame into a plurality of sub areas and executes a motion decision process for each of the sub areas.

For example, the motion decision section 13 applies the following technique. In particular, it calculates a data difference between the preceding frame and the current frame for each sub area and collects those pixels whose data difference is higher than a first threshold value in both of the horizontal direction and the vertical direction. Then, the motion decision section 13 decides that, if the collected values are higher than a second threshold value, the pertaining sub area is a moving picture frame.

Or, the motion decision section 13 applies another technique. In particular, for example, an input video signal is filtered to extract predetermined spatial frequency components and decides whether or not the frame is a moving picture frame from a variation of an image signal obtained by binarizing the extracted spatial frequency components.

Where an entire one frame is a processing object, the methods described require much arithmetic operation processing or a great circuit scale. However, since the processing unit of the motion decision section 13 is a sub area, reduction of the arithmetic operation load and reduction of the circuit scale can be anticipated.

It is to be noted that also a different decision method can be applied as a particular method for motion decision.

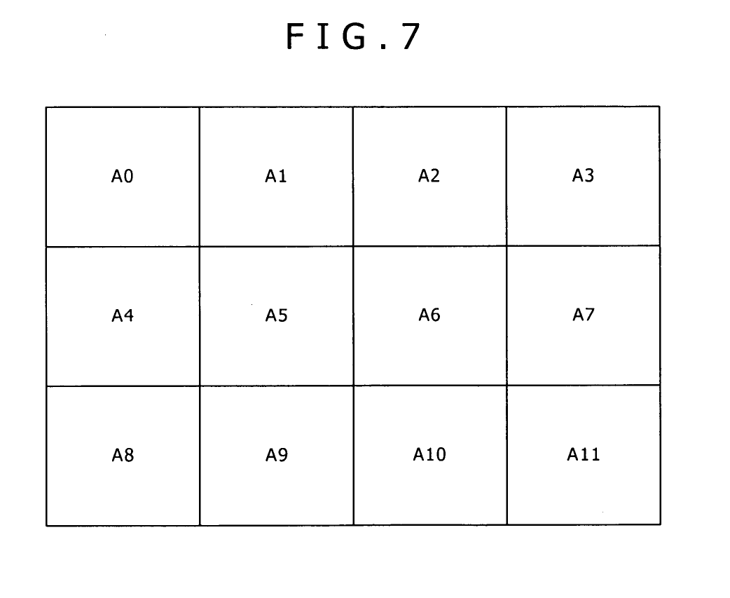

FIG. 7 illustrates an example of division into sub areas which is used in the present form example. FIG. 7 illustrates an example wherein one frame (available display area) is divided into three sub areas in the vertical direction and into four sub areas in the horizontal direction. In other words, the frame is divided into totally 12 areas in three rows and four columns.

It is to be noted that, in the present form example, the frame-specific motion decision section 13B decides that a frame having a high ratio of moving pictures is a moving picture frame and a frame having a low ratio of moving pictures as a still picture frame. Any threshold value may be used as the criterion here. In the present form example, the majority is used as the threshold value.

Where the light emission condition control apparatus 11 according to the form example 1 is adopted, both of high picture quality with regard to a still picture frame and high moving picture responsibility with regard to a moving picture frame can be implemented while the peak luminance is kept fixed.

Further, according to the form example 1, since an arithmetic operation process for decision of a moving picture frame can be executed in a unit of a sub area, reduction of the arithmetic operation burden or reduction of the circuit scale can be anticipated. Consequently, also where a frame is composed of a large number of pixels, a decision process on the real-time basis can be achieved.

C-2. Form Example 2

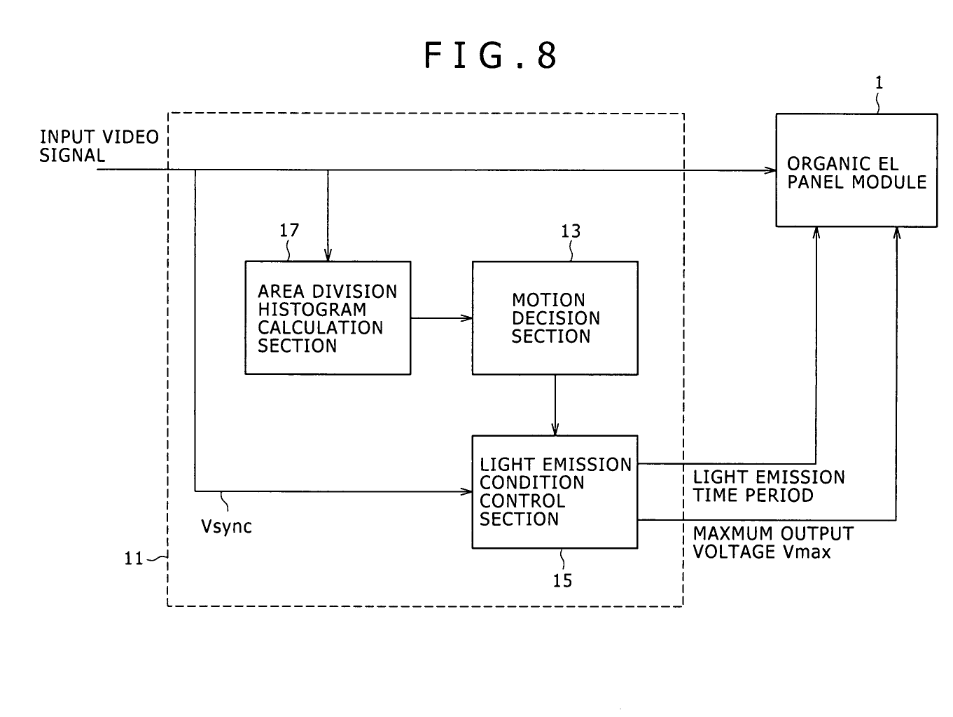

FIG. 8 shows another example of a configuration which is suitably adopted for the light emission condition control apparatus 11.

Referring to FIG. 8, the light emission condition control apparatus 11 according to the present form example includes a motion decision section 13, a light emission condition control section 15, and an area division histogram calculation section 17.

In other words, the light emission condition control apparatus 11 according to the present form example adopts a configuration which newly includes the area division histogram calculation section 17 for performing a preceding process to a moving picture decision process. Together with this, also a motion decision process for individual areas by the motion decision section 13 is optimized.

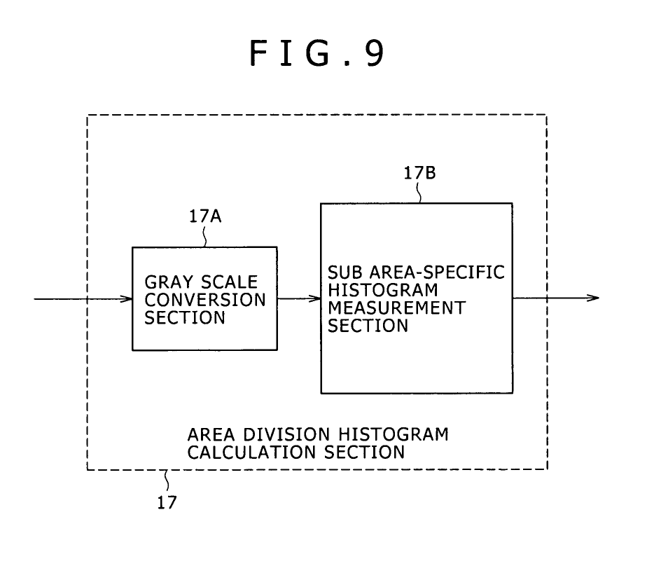

FIG. 9 shows an example of an internal configuration of the area division histogram calculation section 17. Referring to FIG. 9, the area division histogram calculation section 17 includes a gray scale conversion section 17A and a sub area-specific histogram measurement section 17B.

The gray scale conversion section 17A executes a process of converting a color input signal (R, G, B signal) into a white/black gray scale signal. By this signal process, brightness information which a frame image has is extracted.

The sub area-specific histogram measurement section 17B executes a process of dividing one frame into sub areas of M rows and N columns as described hereinabove with reference to FIG. 7 and measuring the frequency distribution (histogram) of gradation values in each sub area.

It is to be noted that the gradation value is equivalent to a gray scale signal value representative of the brightness information. The frequency distribution is given by the numbers of pixels included in individual intervals obtained by dividing the input gradation width with a fixed distance.

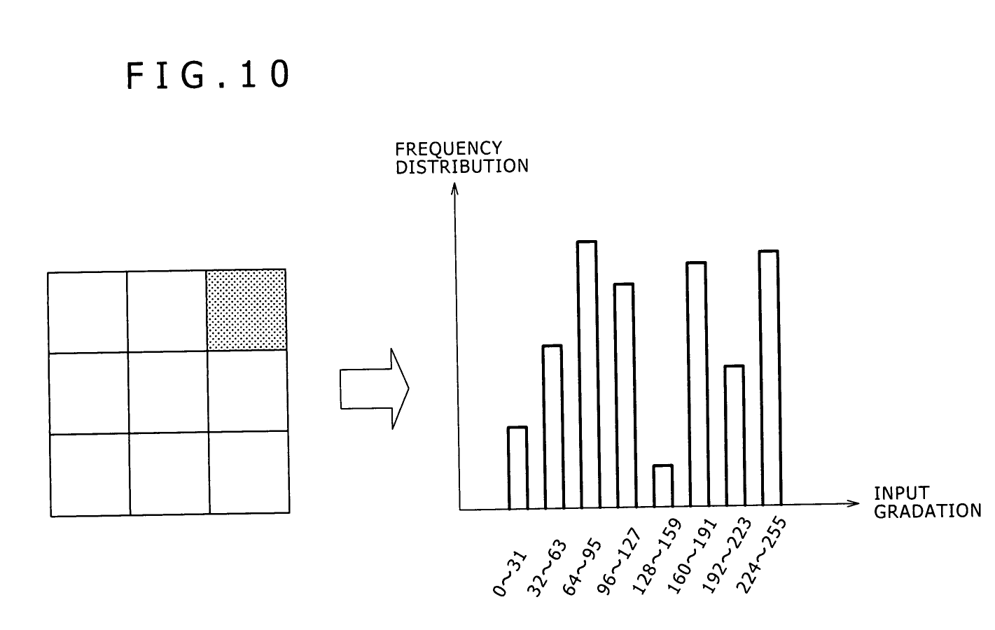

FIG. 10 shows an example of a frequency distribution. In particular, FIG. 10 represents a frequency distribution in a netted sub area from among nine sub areas shown in FIG. 9.

It is to be noted that, in the frequency distribution of FIG. 10, the input gradation width is divided into eight portions. By dividing the input gradation width into eight portions, optimization or minimization of the system can be implemented.

The sub area-specific histogram measurement section 17B outputs frequencies measured in this manner for the individual intervals to the motion decision section 13.

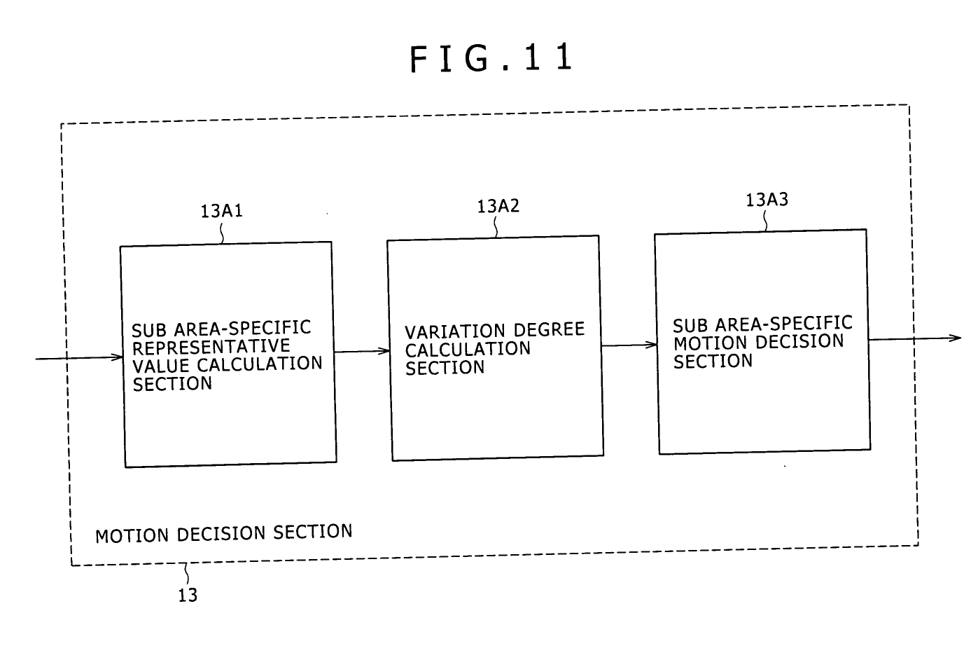

FIG. 11 shows an example of an internal configuration of the motion decision section 13. Referring to FIG. 11, the motion decision section 13 in the present form example includes a sub area-specific representative value calculation section 13A1, a variation degree calculation section 13A2, and a sub area-specific motion decision section 13A3.

The sub area-specific representative value calculation section 13A1 performs weighted arithmetic operation for the frequencies detected with regard to the individual sub areas for each class. Thereupon, the sub area-specific representative value calculation section 13A1 applies comparatively great weights to the classes corresponding to a low gradation region and a high gradation region to calculate representative values Dmn(n) which provide indices to same gradation region components included in the individual sub areas. It is to be noted that the suffix mn represents a sub area positioned at the mth row and the nth column. Further, D(n) represents a representative value of the nth frame.

The reason why such a weighted process as just described is executed is that a factor which has an influence on the picture quality of a moving picture and is likely to be visually recognized is a motion of a body having a high contrast.

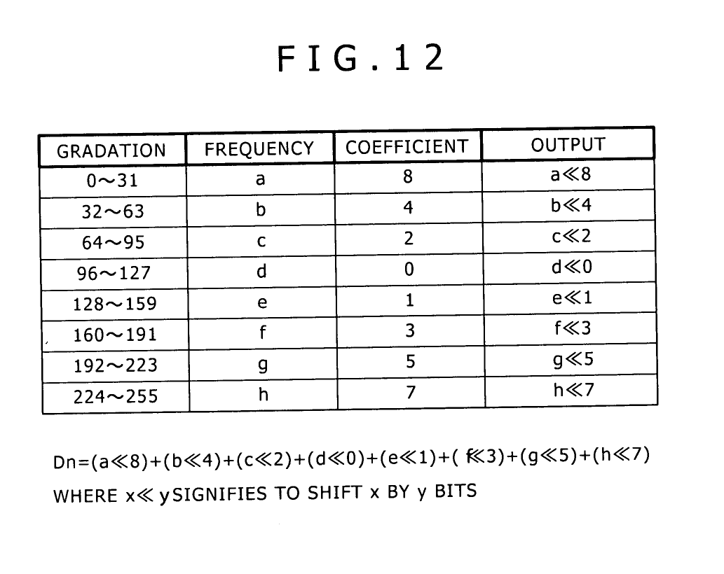

FIG. 12 illustrates an example of weighting. The weighting is implemented by shifting of bit values. In the case of FIG. 12, all weighting coefficients are applied so as not to overlap with each other.

The representative value is calculated as the sum total of the frequencies after the weighting. Consequently, frequency information of a low gradation region and frequency information of a high gradation region can be reflected much on the high bit side of the calculated representative value.

The variation degree calculation section 13A2 executes a process of comparing the representative values calculated with regard to the preceding frame and the current frame for the individually same sub areas to calculate degrees of the variation in the current frame. Resulting values of the process are used for a moving picture decision of the sub areas.

The variation ratio ΔDmn(n) is calculated in accordance with the following expression:
ΔDmn(n)=(|Dmn(n)−Dmn(n−1)|/Dmn(n))×100

In the expression, the suffix mn represents the sub area positioned in the mth row and the nth column. Further, ΔD(n) represents a representative value of the nth frame.

The sub area-specific motion decision section 13A3 executes a process of deciding a sub area, which exhibits a variation ratio higher than a criterion value, as a moving picture area and a sub area, which exhibits a variation ratio lower than the criterion value, as a still picture area.

However, the criterion value differs in value depending upon whether the preceding frame is a moving picture frame or a still picture frame. The reason why two different criterion values are used is that, although a moving picture is likely to appear as a great data variation at an initial stage of movement also in terms of a numerical value, the data variation of a moving picture decreases to a low level at a later stage of the movement.

Therefore, where the criterion value when the preceding frame is a still picture is represented by A and the criterion value when the preceding frame is a moving picture is represented by B, they are set so as to satisfy A>B without fail. It is to be noted that particular values of the criterion values A and B are preferably varied in response to a content to be displayed. Incidentally, where the display content is a television program, preferably the criterion value A is set to A=approximately 15% and the criterion value B is set to B=approximately 10%.

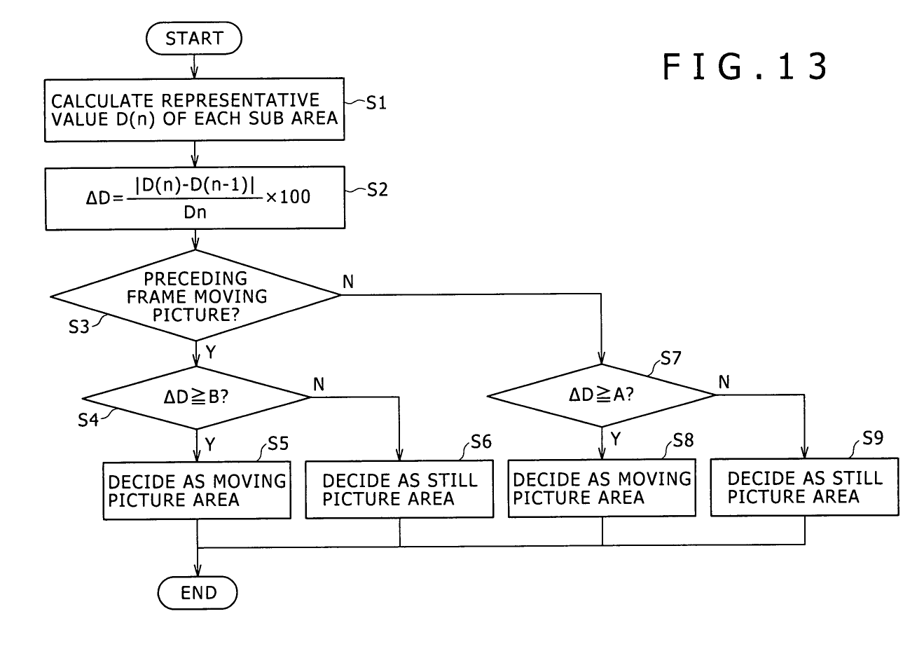

The substance of the process executed by the motion decision section 13 can be represented in such a flow chart as seen in FIG. 13.

Referring to FIG. 13, the sub area-specific representative value calculation section 13A1 first calculates a representative value D(n) of each sub area at step S1. Thereafter, the variation degree calculation section 13A2 calculates a variation ratio ΔD between frames for each sub area at step S2.

The sub area-specific motion decision section 13A3 receives resulting values of the calculation by the variation degree calculation section 13A2 as an input thereto and decides at step S3 whether or not the preceding frame is a moving picture frame. If an affirmative result is obtained, then the processing advances to step S4, but if a negative result is obtained, then the processing advances to step S7.

At step S4, the sub area-specific motion decision section 13A3 compares the criterion value B, which has a comparatively low value, with the variation rate ΔD. If the variation rate ΔD is equal to or higher than the criterion value B, then the sub area-specific motion decision section 13A3 decides at step S5 that the pertaining sub area is a moving picture area. On the other hand, if the variation rate ΔD is lower than the criterion value B, then the sub area-specific motion decision section 13A3 decides at step S6 that the pertaining sub area is a still picture area.

On the other hand, at step S7, the sub area-specific motion decision section 13A3 compares the criterion value A having a relatively higher value with the variation rate ΔD. If the variation rate ΔD is equal to or higher than the criterion value A, then the sub area-specific motion decision section 13A3 decides at step S8 that the pertaining sub area is a moving picture data. On the other hand, if the variation rate ΔD is lower than the criterion value A, then the sub area-specific motion decision section 13A3 decides at step S9 that the pertaining sub area is a still picture area.

The series of decision steps is executed in such a manner as described above, and a result of the decision is supplied from the motion decision section 13 to the light emission condition control section 15.

Referring back to FIG. 8, the light emission condition control section 15 in the present form example controls the driving voltage and the light emission time period which define the light emission condition of the light emission region 3A in response to the moving picture area number provided as a result of the decision thereto.

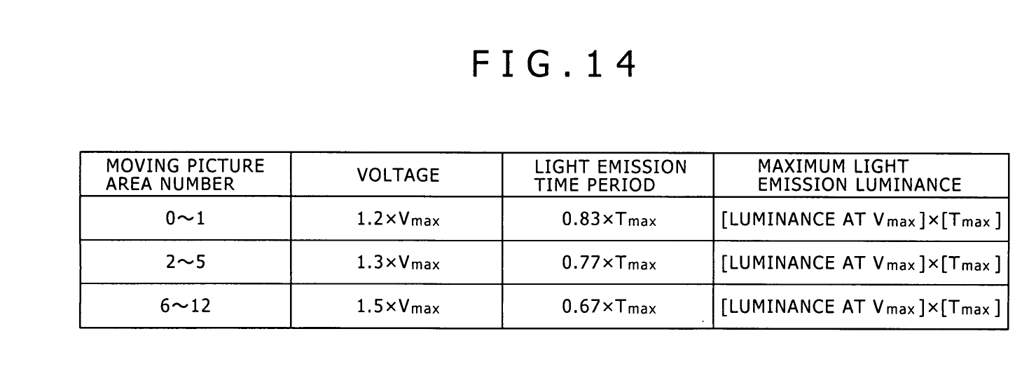

FIG. 14 illustrates an example of the control of the driving voltage and the light emission time period where the voltage and the output luminance have a proportional relationship to each other.

In the example illustrated in FIG. 14, where the number of moving picture areas is equal to or smaller than 1, the voltage is set to 1.5 V, and the light emission time period is set to 0.83×Tmax. Tmax here represents a maximum light time period for one frame.

Where the number of moving picture areas is equal to or greater than 2 but equal to or smaller than 5, the voltage is set to 1.3 V, and the light emission time period is set to 0.77×Tmax. Where the number of moving picture areas is equal to or greater than 6 but equal to or smaller than 12, the voltage is set to 1.5 V, and the light emission time period is set to 0.67×Tmax.

It is to be noted that, in all cases, the maximum light emission luminance is given by the luminance at Vmax×Tmax.

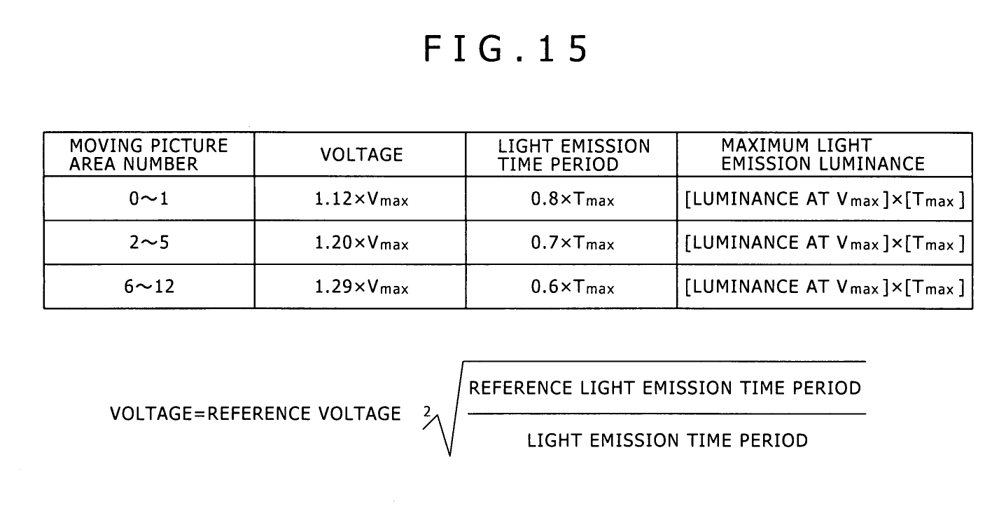

Incidentally, the relationship between the voltage and the output luminance may not be a proportional relationship. FIG. 15 illustrates an example of control of the driving voltage and the light emission time period where the voltage and the output luminance have a non-proportional relationship.

For example, if the voltage and the output luminance have a relationship of γ=square, the driving voltage and the light emission time period are set so as to satisfy a relationship of the voltage=reference voltage×√(reference light emission time period/light emission time period).

In the case of this example, where the number of moving picture areas is equal to or smaller than 1, the voltage for the light emission time period 0.8×Tmax is 1.12 V.

Where the number of moving picture areas is equal to or greater than 2 but equal to or smaller than 5, the voltage for the light emission time period 0.7×Tmax is 1.2 V. Where the number of moving pictures is equal to or greater than 6 but equal to or smaller than 12, the voltage for the light emission time period 0.6×Tmax is 1.29 V.

In all cases, the maximum light emission luminance is given by the luminance at Vmax×Tmax.

As described above, where the light emission condition control apparatus 11 according to the form example 2 is adopted, both of high picture quality with regard to a still picture frame and high moving picture responsibility with regard to a moving picture frame can be implemented while the peak luminance is kept fixed.

Further, in the case of the form example 2, one frame is divided into a plurality of sub areas, and the voltage and the light emission time period which define the light emission condition of the light emission region 3A are controlled based on frequency distributions (histogram) determined with regard to the individual sub areas. Therefore, the necessity for a frame memory for motion decision is eliminated, and further reduction of the arithmetic operation burden and further reduction of the circuit scale can be implemented. Accordingly, also where a frame is composed of a large number of pixels, a decision process on the real-time basis can be achieved.

C-3. Form Example 3

In the present form example, the light emission condition control apparatus 11 performs changeover control of the light emission condition based on motion information involved in an input video signal.

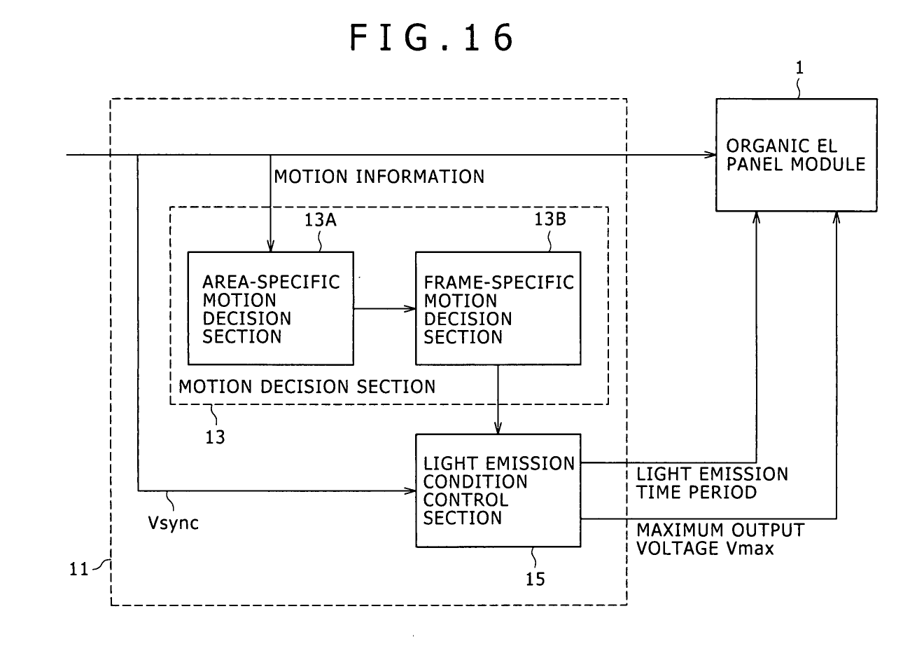

FIG. 16 shows an example of a configuration of the light emission condition control apparatus 11 which adopts the control method just mentioned.

Referring to FIG. 16, the light emission condition control apparatus 11 according to the present form example has a basic configuration similar to that of the form example 1. In particular, the light emission condition control apparatus 11 includes a motion decision section 13 and a light emission condition control section 15.

Also the motion decision section 13 in the preset form example includes an area-specific motion decision section 13A and a frame-specific motion decision section 13B.

The area-specific motion decision section 13A here adopts a technique of deciding, based on motion information included in an input video signal, whether each of encoded areas which form one frame is an interframe encoded moving picture area or an intraframe encoded still picture area. The substance of processing of the frame-specific motion decision section 13B and the light emission condition control section 15 are same as that in the form example 1.

Also where the light emission condition control apparatus 11 according to the form example 3 is adopted, both of high picture quality with regard to a still picture frame and high moving picture responsibility with regard to a moving picture frame can be implemented while the peak luminance is kept fixed.

Further, in the case of the present form example 3, since motion for each sub area is decided based on motion information involved in the input video signal, an arithmetic operation process for the decision process can be eliminated. In other words, where this process is implemented by a logic circuit, the circuit scale can be reduced significantly. Therefore, also where a frame is composed of a large number of pixels, a decision process on the real-time basis can be achieved.

C-4. Form Example 4

In the present form example, the light emission condition control apparatus 11 performs changeover control of the light emission condition based on whether or not a display column for character data is included in a frame screen.

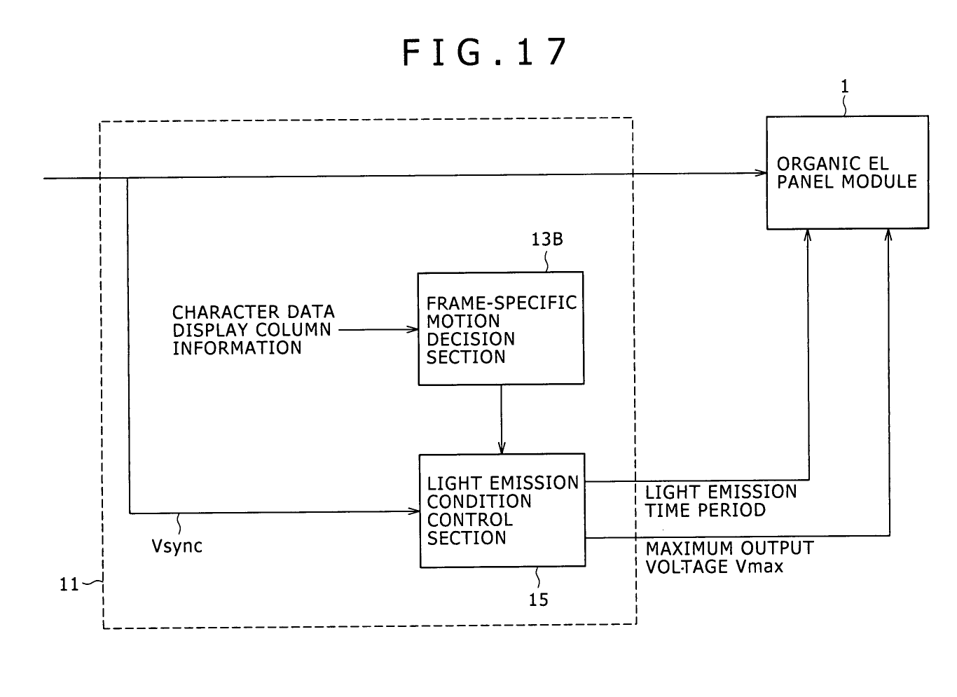

FIG. 17 shows an example of a configuration of the light emission condition control apparatus 11 which adopts the control technique described above.

Referring to FIG. 17, the light emission condition control apparatus 11 includes a frame-specific motion decision section 13B and a light emission condition control section 15.

However, the frame-specific motion decision section 13B in the present form example adopts a technique of deciding a frame including a display column only for character data as a still picture frame and a frame which does not include a display column only for character data as a moving picture frame. The substance of processing of the light emission condition control section 15 is same as that in the form example 1.

Whether or not a display column only for character data is included is decided based on whether or not there is an instruction to display character data broadcast or transmitted in a channel different from that of a main video.

If character data is displayed, then even if the main image is a moving picture, the consciousness of the viewer is concentrated upon the display column for character data. Accordingly, taking this characteristic into consideration, where a display column only for character data is displayed, it is decided that the frame is a still picture frame.

Also where the light emission condition control apparatus 11 according to the form example 4 is adopted, both of high picture quality with regard to a still picture frame and high moving picture responsibility with regard to a moving picture frame can be implemented while the peak luminance is kept fixed.

Further, also in the case of the form example 4, since there is no necessity for a signal process of a main image, the necessity for an arithmetic operation process for the decision process can be eliminated. Consequently, also where a frame is composed of a large number of pixels, a decision process on the real-time basis can be achieved.

C-5. Form Example 5

In the form examples described above, a technique of adjusting the voltage in response to increase or decrease of the light emission time period is described. In the present form example, the light emission condition control apparatus 11 adjusts the gradation value of image data in response to increase or decrease of the light emission time period.

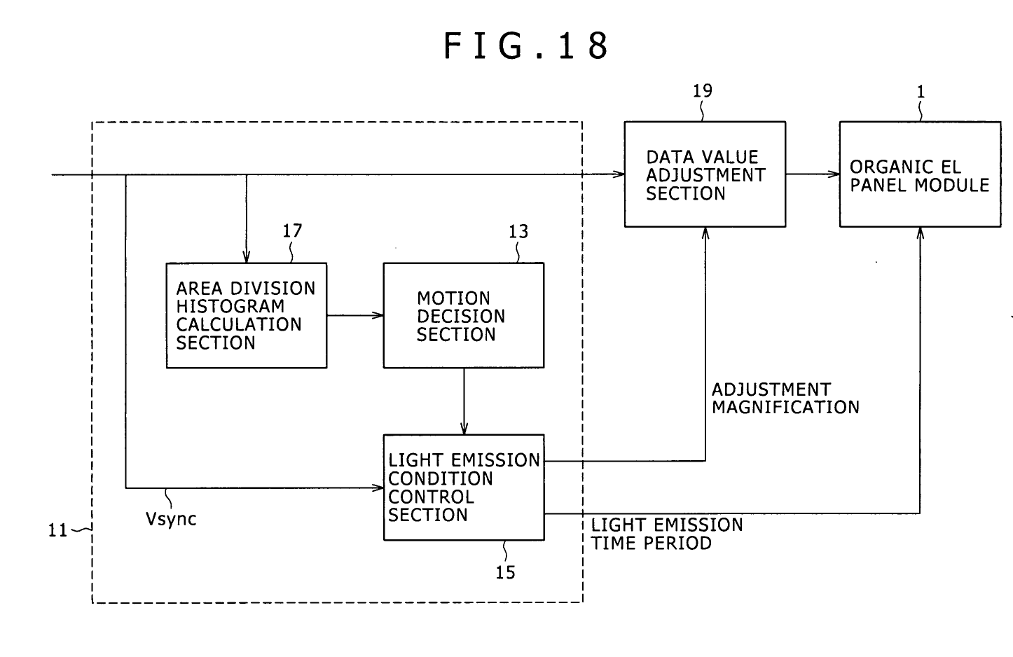

FIG. 18 shows an example of a configuration of the light emission condition control apparatus 11 which adopts the control method just described.

The light emission condition control apparatus 11 according to the present form example adopts the system configuration of the form example 2 although it is possible to adapt the configuration of some other form example.

Therefore, the substance of processing of the area division histogram calculation section 17 and the motion decision section 13 is same as that in the form example 2.

The difference in the substance of processing resides in that the light emission condition control section 15 outputs an adjustment magnification to a data value adjustment section 19 so that the peak luminance may be kept fixed in response to increase or decrease of the light emission time period. The adjustment magnification here is determined in advance using a method similar to that of the control value for a voltage value. The data value adjustment section 19 provides an input video signal amplified according to an adjustment magnification to a data driver of an organic EL panel module.

Also where the light emission condition control apparatus 11 according to the form example 5 is adopted, both of high picture quality with regard to a still picture frame and high moving picture responsibility with regard to a moving picture frame can be implemented while the peak luminance is kept fixed.

Further, also in the case of the form example 5, since an arithmetic operation process for decision of a moving picture frame can be executed in a unit of a sub area, reduction of the arithmetic operation burden and reduction of the circuit scale can be implemented. Consequently, also where a frame is composed of a large number of pixels, a decision process on the real-time basis can be achieved.

E. Other Form Examples

a. In the form examples described above, one frame is divided equally in each of the horizontal direction and the vertical direction so that the number of pixels is equal among resulting sub areas as described hereinabove with reference to FIG. 7.

However, where a display column only for character data is included in a frame, another method may be adopted wherein the dividing distance is determined so that the region except the display column, that is, the display region for a main image, is divided equally and also the display column is divided making use of the dividing distance.

The reason why such a dividing method as just described is adopted is that it is intended to enhance the accuracy in moving picture decision of the display column only for character data. Further, where a motion of an entire frame is to be decided based on the ratio between the moving picture areas and the still picture areas, the adoption of the dividing method described acts in a direction in which the probability of decision of the frame as a still picture frame is raised.

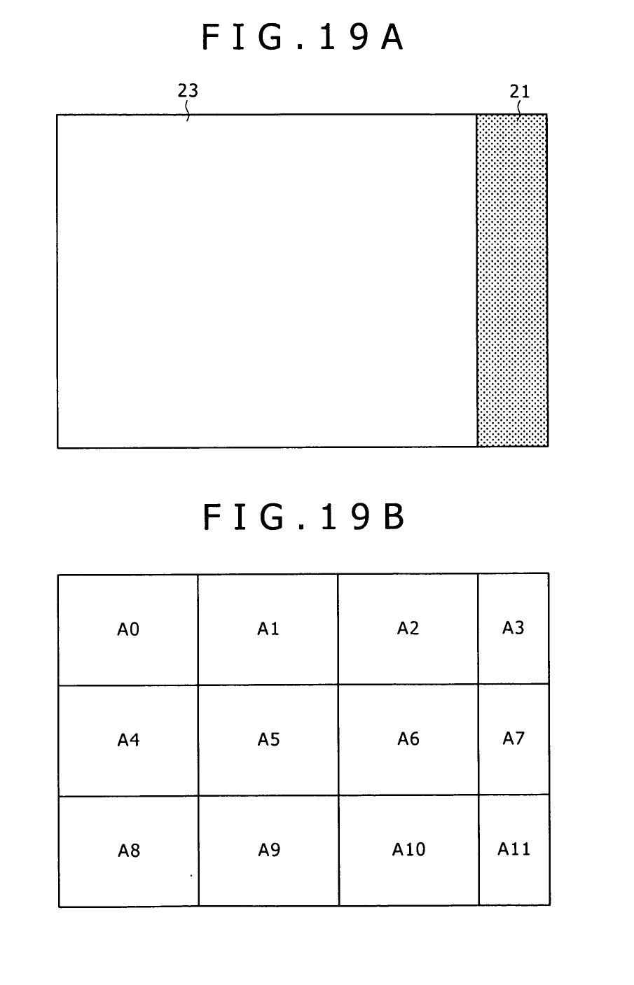

FIGS. 19A to 21B illustrates examples of division. FIG. 19A shows an example wherein a display column 21 only for character data is displayed on the right side of the screen. In this instance, a display region 23 for a main image is divided into nine sub areas as seen in FIG. 19B.

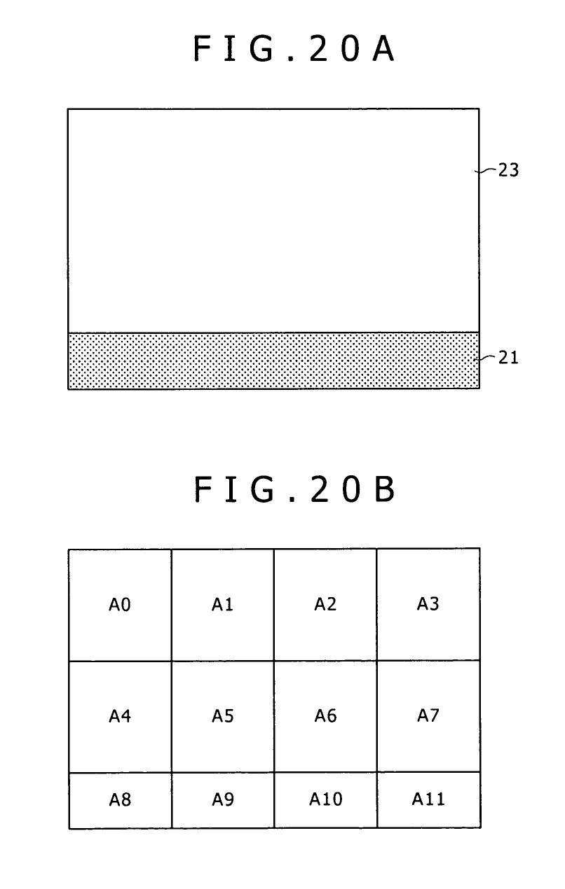

FIG. 20A shows an example wherein a display column 21 only for character data is displayed on the lower side of the screen. In this instance, a display region 23 for a main image is divided into eight sub areas as seen in FIG. 20B.

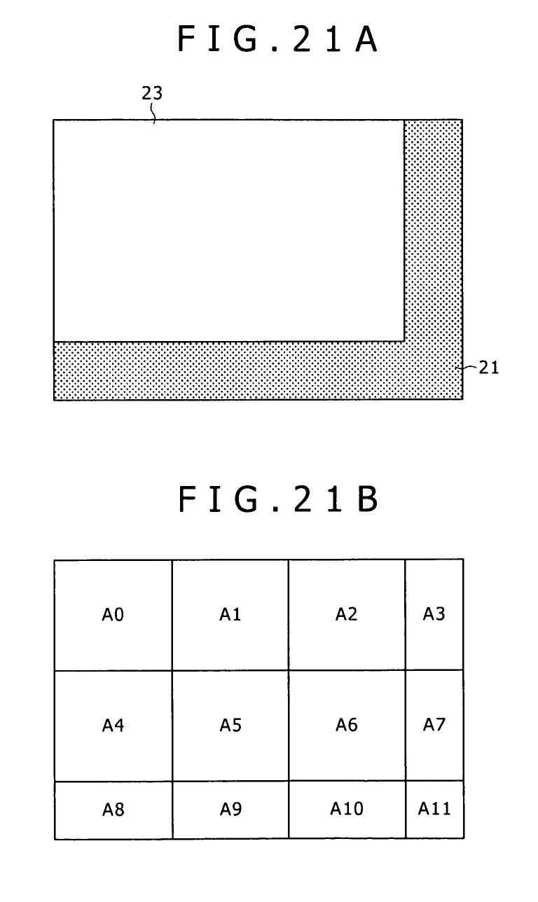

FIG. 21A shows an example wherein a display column 21 only for character data is displayed on both of the right side and the lower side of the screen. In this instance, a display region 23 for a main image is divided into six sub areas as seen in FIG. 21B.

b. In the form example 2 described hereinabove, the control amount of the voltage and the light emission time period is adjusted in response to the rate of a moving picture area which occupies in a result of the decision by the sub area-specific motion decision section.

However, also in this form example, a process of comparing the number of moving picture areas and the number of still picture areas with each other in a unit of one frame and selectively changing over the control amount depending upon whether the number of moving picture areas is greater or smaller than the number of still picture areas may be executed.

c. In the form example 4 described above, the light emission condition is controlled based on whether or not a display column for character data is included in the frame screen. This is intended principally for display of character information received through character broadcasting or through the Internet. However, where a telop which is displayed as part of a main image and has a display form wherein characters are displayed in a flowing fashion in a horizontal direction at a lower portion of a screen can be detected, preferably a method by which, when a telop is displayed, the frame can be decided as a moving picture frame can be adopted. This is because, in order to visually observe characters displayed in a flowing fashion, there is the necessity to raise the moving picture follow-up property.

d. In the form examples described above, the present invention is applied to an organic EL display panel which is a kind of a self luminous display apparatus. However, the present invention can be applied also to other self-luminous display apparatus. For example, the present invention can be applied also to an FED (field emission display) panel, an inorganic EL display panel, an LED panel, a PDP (Plasma Display Panel) or the like.

e. In the form examples described above, the light emission condition control apparatus 11 is mounted on an organic EL display panel.

However, such an organic EL display panel as described above or any other display apparatus may be in the form of a sole commodity or may be incorporated as part of some other image processing apparatus. For example, the device mentioned can be implemented as a display device for a video camera, a digital camera or other image pickup apparatus (including a camera unit and also an image pickup apparatus formed integrally with a recording apparatus), an information processing terminal (portable computer, portable telephone set, portable game machine, electronic notebook and so forth) and a game machine.

f. In the form examples described above, the light emission condition control apparatus 11 is mounted on an organic EL display panel.

However, the light emission condition control apparatus 11 may be incorporated in an image processing apparatus side which supplies an input video signal to an organic EL display panel or other display apparatus. In this instance, a system for supplying a duty pulse or a voltage value from the image processing apparatus to the display apparatus may be adopted, or alternatively another system wherein information indicating a duty pulse or a voltage value is supplied from the information processing apparatus to the display apparatus may be adopted.

g. In the form examples described above, the light emission condition control apparatus 11 is described from the point of view of a functional configuration. However, it is a matter of course that equivalent functions can be implemented as hardware and also as software.

Further, all of the processing functions may be implemented as hardware or software, or part of the processing functions may be implemented using hardware or software. In other words, a combination configuration of hardware and software may be adopted.

h. The form examples described hereinabove may be modified in various manners within the spirit and scope of the present invention. Further, also various modifications and applications may be created or combined based on the disclosure of the present invention.

While a preferred embodiment of the present invention has been described using specific terms, such description is for illustrative purpose, and it is to be understood that changes and variations may be made without departing from the spirit or scope of the following claims.

What is claimed is:

1. A self-luminous display apparatus including a light emission panel whose light emission time period can be varied within a period of one frame, comprising:
an area-specific motion decision section configured to make a decision between a moving picture area and a still picture area for each one frame;
a frame-specific motion decision section configured to decide a frame having a high ratio of moving picture areas as a moving picture frame but decide a frame having a low ratio of moving picture areas as a still picture frame; and
a light emission condition control section configured to control, when a frame decided as a moving picture frame by said frame-specific motion decision section is to be displayed, so that a peak luminance to be visually observed may be kept fixed and to decrease the light emission time period of said light emission panel from a reference light emission time period.

2. The self-luminous display apparatus according to claim 1, wherein said area-specific motion decision section executes, when a display column only for character data is not included in a processing object frame, the decision process for each of sub areas obtained by equally dividing an entire display area, but executes, when a display column only for character data is included in the processing object frame, the decision process for first sub areas defined by equally dividing the area of the entire display area except the display column and second sub areas obtained by dividing the display column in a longitudinal direction using size information of the first sub area.

3. A self-luminous display apparatus including a light emission device whose light emission time period can be varied within a period of one frame, comprising:
a frequency distribution measurement section configured to detect a frequency distribution of gradation values which provide luminance components of a video signal for each of sub areas which form one frame;
a sub area-specific representative value calculation section configured to perform weighted arithmetic operation of the frequencies detected with regard to each sub area for each class such that comparatively great weights are applied to the classes corresponding to a low gradation region and a high gradation region to calculate representative values which provide indices to same gradation region components included in the individual sub areas;
a variation degree calculation section configured to compare the representative values calculated with regard to a preceding frame and a current frame for the individually same sub areas to calculate the degree of variation on the current frame;
a sub area-specific motion decision section configured to decide a sub area having a variation degree greater than or equal to a criterion value as a moving picture area but decide a sub area having a variation degree lower than the criterion value as a still picture area;
a frame-specific motion decision section configured to compare the number of moving picture areas and the number of still picture areas with each other in a unit of one frame and decide a sub area as a moving picture area if the number of moving picture areas thereof is equal to or greater than the number of still picture areas thereof but decide a sub area as a still picture area if the number of still picture areas thereof is greater than the number of moving picture areas thereof; and
a light emission condition control section configured to control, when a frame decided as a moving picture frame by said frame-specific motion decision section is to be displayed, so that a peak luminance to be visually observed may be kept fixed and to decrease the light emission time period of said light emission panel from a reference light emission time period.

4. The self-luminous display apparatus according to claim 3, wherein said sub area-specific representative value calculation section uses a higher weight for a comparatively low gradation and besides uses a higher weight for a comparatively high gradation.

5. The self-luminous display apparatus according to claim 3, wherein, where it is decided that the preceding frame is a still picture frame, said sub area-specific motion decision section uses a comparatively high first reference value as the criterion value, but where it is decided that the preceding frame is a moving picture frame, said sub area-specific motion decision section uses a comparatively low second reference value as the criterion value.

6. A self-luminous display apparatus including a light emission device whose light emission time period can be varied within a period of one frame, comprising:
a frequency distribution measurement section configured to detect a frequency distribution of gradation values which provide luminance components of a video signal for each of sub areas which form one frame;
a sub area-specific representative value calculation section configured to perform weighted arithmetic operation of the frequencies detected with regard to each sub area for each class such that comparatively great weights are applied to the classes corresponding to a low gradation region and a high gradation region to calculate representative values which provide indices to same gradation region components included in the individual sub areas;
a variation degree calculation section configured to compare the representative values calculated with regard to a preceding frame and a current frame for the individually same sub areas to calculate the degree of variation on the current frame;
a sub area-specific motion decision section configured to decide a sub area having a variation degree greater than or equal to a criterion value as a moving picture area but decide a sub area having a variation degree lower than the criterion value as a still picture area; and
a light emission condition control section configured to control, in response to the ratio between the number of moving picture areas and the number of still picture areas in a unit of one frame, so that a peak luminance to be visually observed may be kept fixed and to decrease the light emission time period of said light emission panel from a reference light emission time period.

7. A self-luminous display apparatus including a light emission panel whose light emission time period can be varied within a period of one frame, comprising:
an area-specific motion decision section configured to decide, based on motion information included in an input video signal, whether each of encoded areas which form one frame is an interframe encoded moving picture area or an intraframe encoded still picture area;
a frame-specific motion decision section configured to decide that a frame which exhibits a high ratio of moving picture frames is a moving picture frame but a frame which exhibits a low ratio of moving picture frames is a still picture frame; and
a light emission condition control section configured to control, when a frame decided as a moving picture frame is to be displayed, so that a peak luminance to be visually observed may be kept fixed and to decrease the light emission time period of said light emission panel from a reference light emission time period.

8. A self-luminous display apparatus including a light emission panel whose light emission time period can be varied within a period of one frame, comprising:
a frame-specific motion decision section configured to decide that a frame which includes a display column only for character data is a still picture frame but a frame which does not include a display column only for character data is a moving picture frame; and
a light emission condition control section configured to control, when a frame decided as a moving picture frame is to be displayed, so that a peak luminance to be visually observed may be kept fixed and to decrease the light emission time period of said light emission panel from a reference light emission time period.

9. A light emission condition control apparatus capable of varying a light emission time period of a light emission panel within a period of one frame, comprising:
an area decision section configured to decide moving picture areas and still picture areas for every one frame;
a frame-specific motion decision section configured to decide that a frame which exhibits a high ratio of moving picture frames is a moving picture frame but a frame which exhibits a low ratio of moving picture frames is a still picture frame; and
a light emission condition control section configured to control, when a frame decided as a moving picture frame is to be displayed, so that a peak luminance to be visually observed may be kept fixed and to decrease the light emission time period of said light emission panel from a reference light emission time period.

10. A light emission condition control method for varying a light emission time period of a light emission panel within a period of one frame, comprising the steps of:
deciding moving picture areas and still picture areas for every one frame;
deciding that a frame which exhibits a high ratio of moving picture frames is a moving picture frame but a frame which exhibits a low ratio of moving picture frames is a still picture frame; and
controlling, when a frame decided as a moving picture frame is to be displayed, so that a peak luminance to be visually observed may be kept fixed and decreasing the light emission time period of said light emission panel from a reference light emission time period.

11. A program for causing a computer, which variably controls a light emission time period of a light emission panel within a period of one frame, to execute:
a process of deciding moving picture areas and still picture areas for every one frame;
a process of deciding that a frame which exhibits a high ratio of moving picture frames is a moving picture frame but a frame which exhibits a low ratio of moving picture frames is a still picture frame; and
a process of controlling, when a frame decided as a moving picture frame is to be displayed, so that a peak luminance to be visually observed may be kept fixed and decreasing the light emission time period of said light emission panel from a reference light emission time period.
